(19) United States
(12) Patent Application Publication
(10) Pub. No.: US 2017/0206249 A1
(43) Pub. Date: Jul. 20, 2017

(54) SYSTEMS AND METHODS FOR IMPLEMENTING URBAN VOICES

(71) Applicant: SYSTEMS AND METHODS FOR IMPLEMENTING URBAN VOICES, LAS VEGAS, NY (US)

(72) Inventor: Dmitri Pitirimov, Torrance, CA (US)

(21) Appl. No.: 15/001,245

(22) Filed: Jan. 20, 2016

(51) Int. Cl. G06F 17/30; H04L 12/58

(52) U.S. Cl. CPC G06F 17/30489; H04L 51/32; G06F 17/30321; G06F 17/30554

(57) ABSTRACT

Urban voices service is a real-time social media message wall that integrates content from different social networks on a single wall creating a convenient channel to broadcast information about topics and events. In one or more embodiments, the described urban voices service provides a list of event hashtags and a corresponding array of relevant publications to Internet users and event visitors attracting and involving other users of information space and increasing an interactive experience of the event. In one or more embodiments, the described urban voices service may be used to provide a two-way communication solution between spokesperson and audience that allows broadcasting on a single “wall” (e.g. in a single online forum) of official event information and audiovisual or textual broadcast, audience questions as well as answers to those questions.

### BACKGROUND OF THE INVENTION

Technical Field

The disclosed embodiments relate in general to social networking technology and, more specifically, to systems and methods for implementing urban voices.

Description of the Related Art

The use of hashtag (“#”) as a social media publication format has provided an ability to easily differentiate social network's activities related to a particular brand, person or newsbreak and allowed for everybody to track these activities. Thereby, the hashtag promotion became an effective tool for increasing social presence of brand, newsbreak, person, etc.

Despite the conveniences offered by the hashtag, conventional social networking technology does not offer a single resource that integrates together content from different social networks. On the other hand, having such resource would be advantageous and desirable as it would provide a convenient channel to broadcast various information about a events, topics of social significance, etc.

### SUMMARY OF THE INVENTION

The embodiments described herein are directed to methods and systems that substantially obviate one or more of the above and other problems associated with the conventional social networking technology.

In accordance with one aspect of the inventive concepts described herein, there is provided a computerized system for integrating content from different social networks on a single message wall, the system comprising: a pulling system comprising at least one processing unit and a memory for periodically collecting social media data based on a search query; a message processing service comprising at least one processing unit and a memory for removing duplicates from the collected social media data and for saving the deduplicated collected social media data to a database; a search service comprising at least one processing unit and a memory for indexing the deduplicated collected social media data; and a front-end interface for displaying at least a portion of the deduplicated collected social media data to the user.

In one or more embodiments, the pulling system comprises a pulling demon, a pulling worker and a database.

In one or more embodiments, the database is Redis DB.

In one or more embodiments, the message processing service facilitates pre-moderation of the collected social media data.

In one or more embodiments, the message processing service facilitates post-moderation of the collected social media data.

In accordance with another aspect of the inventive concepts described herein, there is provided a computer-implemented method for integrating content from different social networks on a single message wall, the method comprising: using a pulling system comprising at least one processing unit and a memory for periodically collecting social media data based on a search query; using a message processing service comprising at least one processing unit and a memory for removing duplicates from the collected social media data and for saving the deduplicated collected social media data to a database; using a search service comprising at least one processing unit and a memory for indexing the deduplicated collected social media data; and displaying at least a portion of the deduplicated collected social media data to the user.

In accordance with yet another aspect of the inventive concepts described herein, there is provided a non-transitory computer-readable medium embodying a set of computer-executable instructions, which, when executed in a computerized system comprising a central processing unit, a display device and a memory, cause the computerized system to perform a method for integrating content from different social networks on a single message wall, the method comprising: using a pulling system comprising at least one processing unit and a memory for periodically collecting social media data based on a search query; using a message processing service comprising at least one processing unit and a memory for removing duplicates from the collected social media data and for saving the deduplicated collected social media data to a database; using a search service comprising at least one processing unit and a memory for indexing the deduplicated collected social media data; and displaying at least a portion of the deduplicated collected social media data to the user.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive concepts. Specifically:

FIG. 1 illustrates an exemplary embodiment of the described urban voices service and an exemplary embodiment of its algorithm.

FIG. 2 illustrates an exemplary embodiment of a system architecture of the described urban voices service.

FIG. 3 illustrates an exemplary embodiment of an algorithm of the described urban voices service.

FIG. 4(a) illustrates an exemplary embodiment of a user interface of the settings screen of the described urban voices service.

FIG. 4(b) illustrates an exemplary embodiment of a manual pre-moderation page.

FIGS. 4(c) and 4(d) illustrate exemplary embodiments of the wall interface.

FIG. 4(e) illustrates an exemplary embodiment of a post-moderation page.

FIG. 4(f) illustrates an exemplary embodiment of a statistics interface.

FIG. 5 illustrates an exemplary embodiment of a computerized platform upon which the described urban voices service may be deployed.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In accordance with one of the embodiments, the urban voices service described herein magnifies event's or topic's information field, motivates audience to do more publications on a socially significant subject and provides a single communication platform for internet audience and event organizers. The service can be widely used for collection and broadcasting of user generated content.

In one or more embodiments, urban voices service is a real-time social media message wall that integrates content from different social networks on a single wall creating a convenient channel to broadcast information about topics and events. In one or more embodiments, the described urban voices service provides a list of event hashtags and a corresponding array of relevant publications to internet users and event visitors attracting and involving other users of information space and increasing an interactive experience of the event. In one or more embodiments, the described urban voices service may be used to provide a two-way communication solution between spokesperson and audience that allows broadcasting on a single “wall” (e.g. in a single online forum) of official event information and audiovisual or textual broadcast, audience questions as well as answers to those questions.

In one or more embodiments, the functionality of the described service allows one to aggregate together any social network content such as text, images or video. Accordingly, the described urban voices service can be used for various types of events ranging from conferences to BTL services. In one or more embodiments, the described urban voices service additionally provides real-time and post-event analytics with the ability to export event's publications archive for further use.

### Urban Voices Service

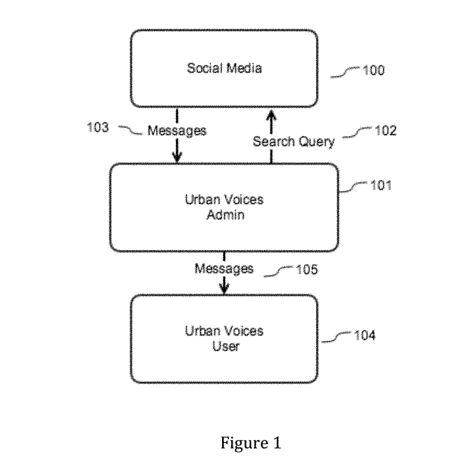

FIG. 1 illustrates an exemplary embodiment of the described urban voices service and an exemplary embodiment of its algorithm. As shown in that figure, urban voices service fetches messages (103) from social media (100) according to a search query (102). Search query (102) is generated based on specified settings (social media, hashtags, obscene and forbidden words, blacklist and whitelist users). Selected messages (103) go through manual pre-moderation process if required and are presented to user (104) on the wall.

### System Architecture of the Urban Voices Service

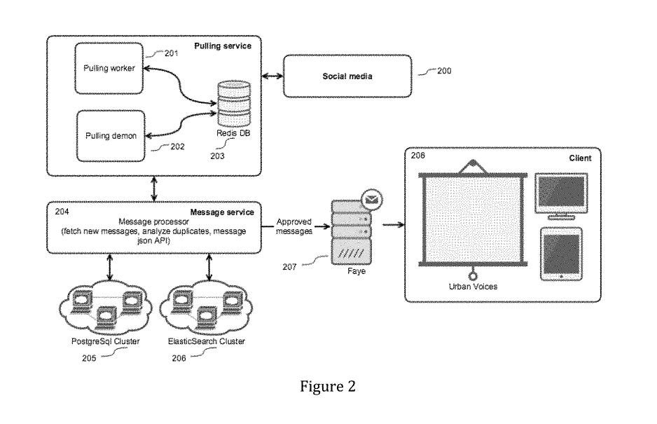

FIG. 2 illustrates an exemplary embodiment of a system architecture of the described urban voices service. As shown in that figure, pulling demon (202) passes a search query to the pulling worker (201) through the Redis DB (203). In one or more embodiments, pulling worker collects social media data (200) periodically. Message service (204) removes duplicates and saves new messages to PostgreSQL DB (205). Social media data are fetched from social providers via HTTP protocol and processed in multiple worker processes (201). Part of the data stored in PostgreSQL DB is copied to the ElasticSearch server where full text indexing is applied (206). Message service (204) interacts with front-end interface (208) in real time through the publish-subscribe messaging system FAYE (207). In one or more embodiments, PostgreSQL and ElasticSearch are deployed in cluster mode for horizontal scalability and physically located in different data centers to ensure fault tolerance. In one or more embodiments, urban voices provides REST API for third-party data services.

In various embodiments, the databases (205) may be implemented based on any now known or later developed type of database software, such as a relational database management system, including, without limitation, MySQL, Oracle, SQL Server, DB2, SQL Anywhere, SQLite, and/or PostgreSQL, which are well-known to persons of skill in the art. In an alternative embodiment, a cloud-based distributed database, such as Amazon Relational Database Service (Amazon RDS), well known to persons of ordinary skill in the art, may also be used to implement the database (205).

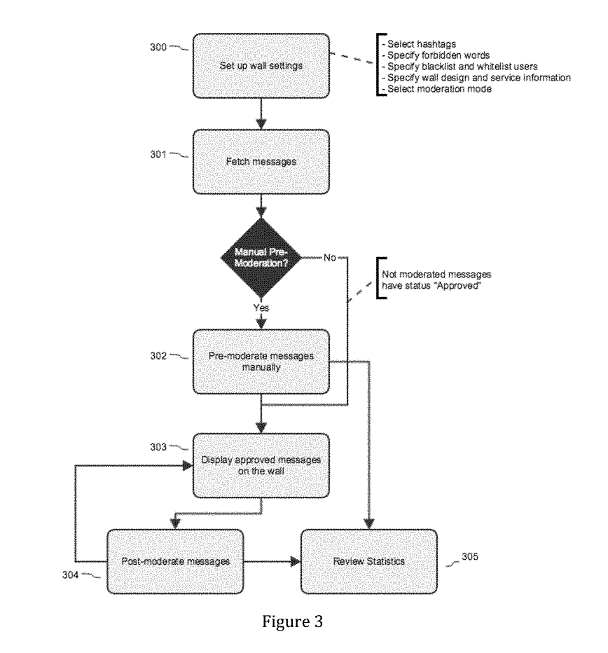

FIG. 3 illustrates an exemplary embodiment of an algorithm of the described urban voices service. Specifically, at step 300, the wall settings are setup by the administrator. In various embodiments, during this step, the administrator may select hashtags, specify forbidden words, specify blacklisted and whitelisted users, specify wall design and service information, and select moderation mode (e.g. manual or none).

At step 301, new messages are fetched. If the manual pre-moderation was specified, the operation proceeds to step 302, wherein messages are pre-moderated manually. The approved messages are subsequently displayed on the wall in step 303. If no moderation was specified, the messages are automatically displayed bypassing the manual moderation step 302.

At step 304, the messages may be post-moderated. Finally, various statistics described in detail below may be reviewed in step 305.

### Settings

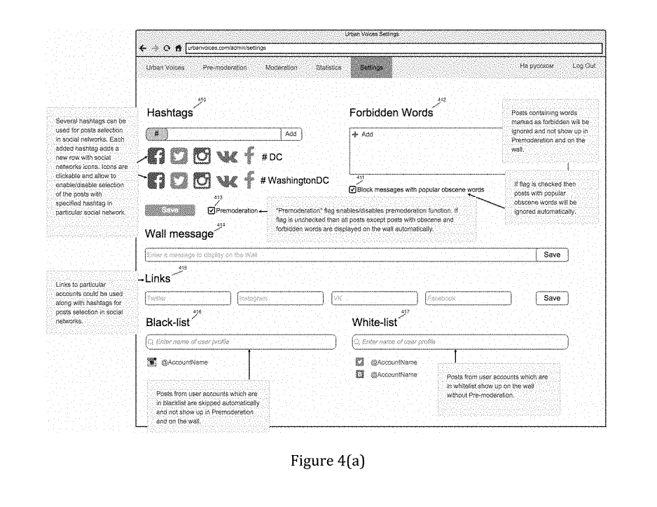

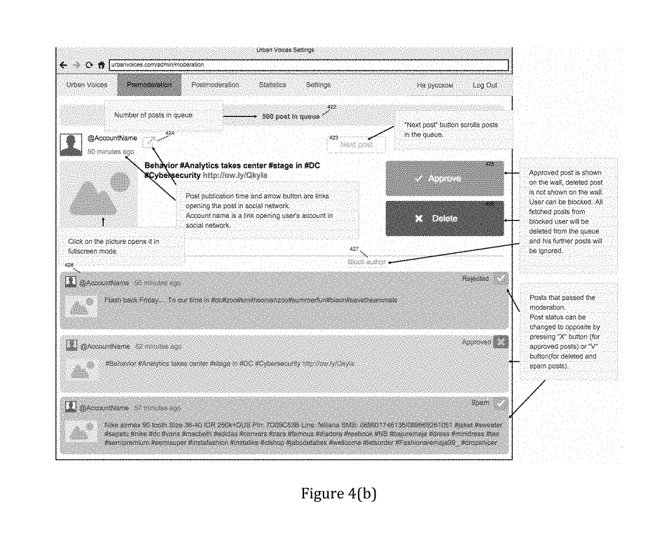

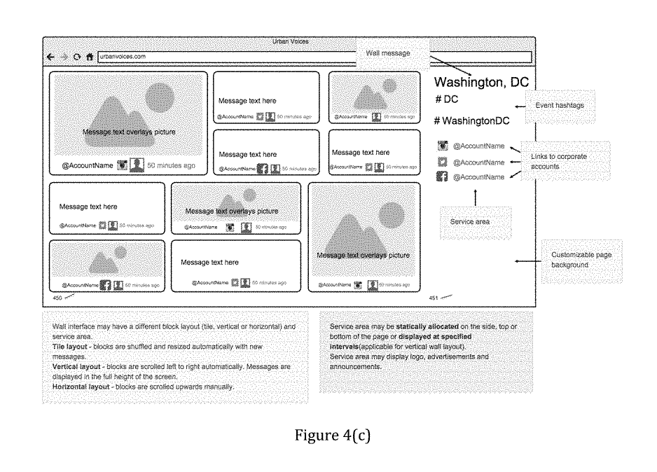

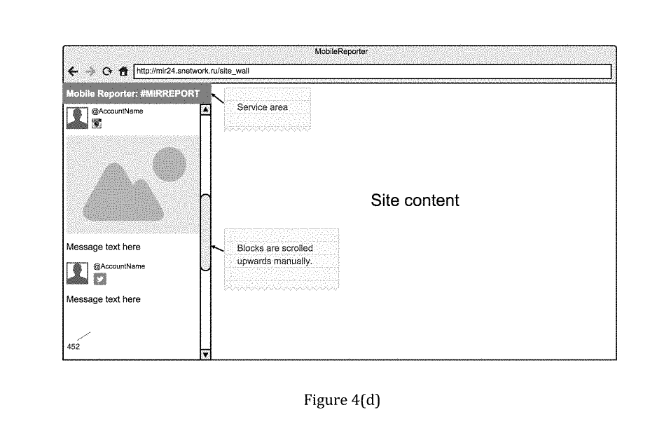

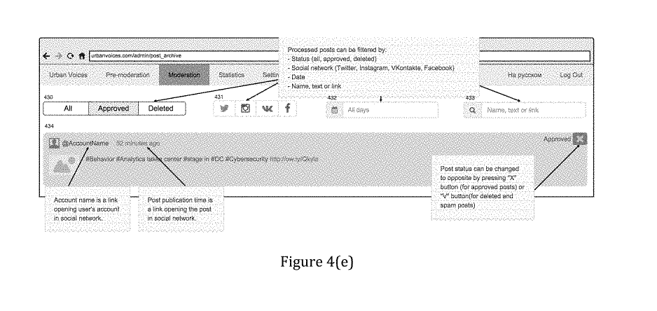

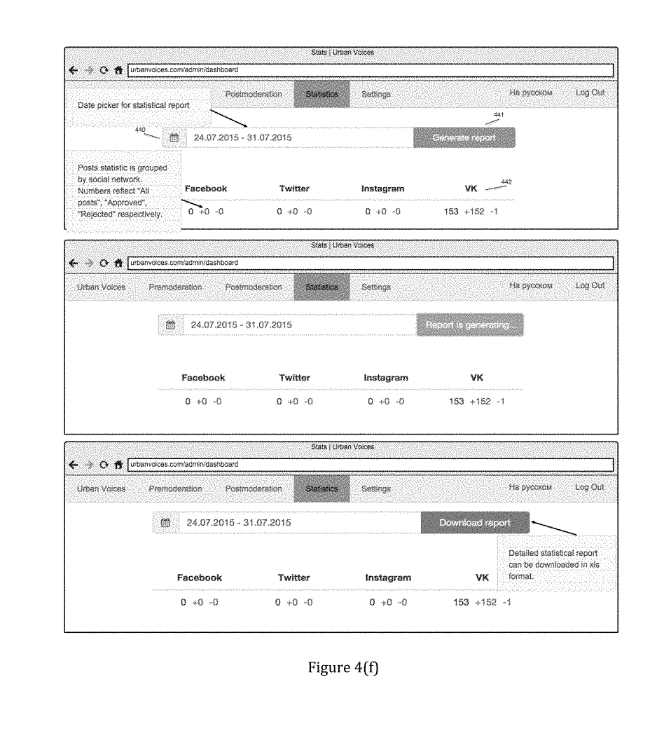

FIG. 4(a) illustrates an exemplary embodiment of the user interface of the settings screen of the described urban voices service. Urban Voices administrator (101) sets up service settings (300). Settings allow to define list of event hashtags (410) and specify which social networks to process for each particular hashtag. At least one hashtag has to be specified to initiate service start.

In one or more embodiments, additional settings can be set to ensure content quality and avoid inappropriate content reaching the wall, messages with popular obscene words can be filtered automatically (411). If flag (411) is set then messages containing such words will be filtered off and not show up in the message queue.

In one or more embodiments, particular forbidden words can be specified (412). If message contain a word marked as “forbidden” then this message will be filtered off and not show up in the message queue. Selected users can be added to blacklist (416) and their messages will be ignored automatically. Selected users can be added to whitelist (417) and their messages will be shown on the wall bypassing manual moderation process.

In one or more embodiments, manual Pre-moderation function (413) is optional and can be enabled/disabled. If flag is turned on then all messages (103) will go through the manual pre-moderation process performed by Administrator (101). In one or more embodiments, a wall message (e.g. event name) (414) is shown on the wall in service area if specified (451). In one or more embodiments, links to corporate accounts (415) are shown on the wall in service area if specified (451).

In one or more embodiments, settings can be updated any time during event.

### Manual Pre-Moderation

In one or more embodiments, during manual pre-moderation process (302), administrator verifies selected content for compliance. On the manual pre-moderation page illustrated in FIG. 4(b), messages are displayed in compliance with message queue (422). In one or more embodiments, the message queue length is customizable for optimal system performance.

In one or more embodiments, each message contains information about user account and publication time (424). Messages in the queue are scrollable (423), each message requires to be either approved (425) or rejected (426). Selected user may be blocked (427). If user is blocked then his message is marked as “spam”, all his current messages are removed from the queue and further messages are ignored. In one or more embodiments, verified messages (428) are displayed on a bottom part of the manual pre-moderation page. These messages can be re-verified and their status can be changed.

### Wall Interface

Approved messages that have already passed the manual pre-moderation process are displayed (303) on the wall interface, embodiments of which are illustrated in FIGS. 4(c) and 4(d).

In one or more embodiments, the wall interface shown in FIG. 4(c) may have different block layout (tile, vertical or horizontal) (450, 452) and service area (451). Some non-limiting exemplary layouts of the wall interface are the following:
Tile layout—blocks are shuffled and resized automatically with new messages;
Vertical layout—blocks are scrolled left to right automatically. Messages are displayed in full height of the screen;
Horizontal layout—blocks are scrolled upwards manually.

In one or more embodiments, service area may be statically allocated on a side, top or bottom of the page or displayed at specified intervals (applicable for vertical wall layout). In one or more embodiments, service area (451) displays information block with event's hashtags and corporate accounts.

In one or more embodiments, the wall interface is customizable and allows to:
Select wall background;
Add logos;
Inject videos, advertisement and announcements to service area;
Alternate messages with advertisement/announcements;
Enable/disable message information such as user account, publication date, social media;
Customize frequency of publication change.

In one or more embodiments, urban voices service widget can be used in websites, as shown in FIG. 4(d).

### Post-Moderation

In one or more embodiments, if manual pre-moderation setting is turned-off then all messages are considered “Approved” and displayed on the wall, see FIGS. 4(c) and 4(d) directly bypassing any administrative verification. Post-moderation (304) is available for all fetched messages and allows to handpick each message, update its status and add or remove message to/from the wall.

FIG. 4(e) illustrates an exemplary embodiment of a post-moderation page. In one or more embodiments, post-moderation page displays a list of fetched and pre-moderated (if applicable) messages (434) including information about user account and publication date.

In one or more embodiments, messages can be filtered by:
Status (All, Approved, Deleted) (430);
Social Media (431);
Dates (432);
User account (433);
Message content (433).

### Statistics

FIG. 4(f) illustrates an exemplary embodiment of a statistics interface. Statistics user interface illustrated in FIG. 4(f) displays real-time statistics (305) and allows to quickly identify how many people involved/interact in the event (442). In one or more embodiments, a statistical report (not shown) can be generated for selected period of time (440) and downloaded (441) in XLS format.

In one or more embodiments, the statistical report may contain the following information grouped by social media:
Post publication date and time;
Post content;
User name;
Post link to the social media;
User profile link;
State (approved, rejected);
Total posts by user;
Total published posts by user;
Total declined posts by user.

In one or more embodiments, number of tabs in statistical report depends on whether or not messages from particular social media has been found. If no messages with specified hashtag were found in particular social media then that social media tab will be hidden.

### Exemplary Computer Platform

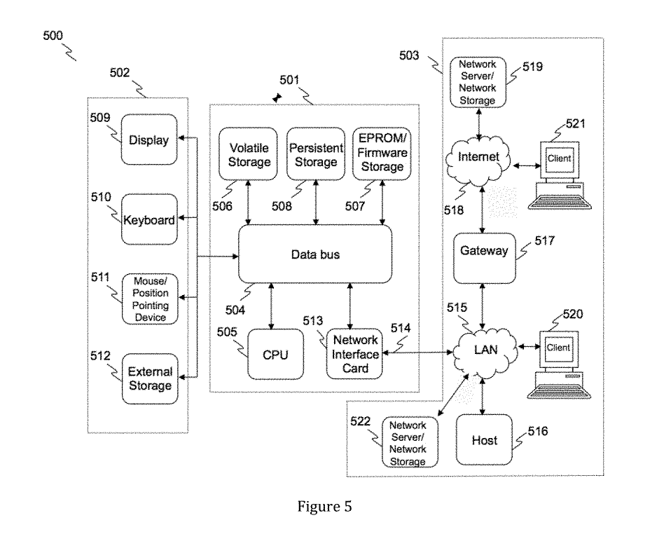

FIG. 5 is a block diagram that illustrates an embodiment of a computer system 500 upon which various embodiments of the inventive concepts described herein may be implemented. The system 500 includes a computer platform 501, peripheral devices 502 and network resources 503.

The computer platform 501 may include a data bus 504 or other communication mechanism for communicating information across and among various parts of the computer platform 501, and a processor 505 coupled with bus 504 for processing information and performing other computational and control tasks. Computer platform 501 also includes a volatile storage 506, such as a random access memory (RAM) or other dynamic storage device, coupled to bus 504 for storing various information as well as instructions to be executed by processor 505, including the software application for proxy detection described above. The volatile storage 506 also may be used for storing temporary variables or other intermediate information during execution of instructions by processor 505. Computer platform 501 may further include a read only memory (ROM or EPROM) 507 or other static storage device coupled to bus 504 for storing static information and instructions for processor 505, such as basic input-output system (BIOS), as well as various system configuration parameters. A persistent storage device 508, such as a magnetic disk, optical disk, or solid-state flash memory device is provided and coupled to bus 504 for storing information and instructions.

Computer platform 501 may be coupled via bus 504 to a touch-sensitive display 509, such as a cathode ray tube (CRT), plasma display, or a liquid crystal display (LCD), for displaying information to a system administrator or user of the computer platform 501. An input device 510, including alphanumeric and other keys, is coupled to bus 504 for communicating information and command selections to processor 505. Another type of user input device is cursor control device 511, such as a mouse, a trackball, or cursor direction keys for communicating direction information and command selections to processor 505 and for controlling cursor movement on touch-sensitive display 509. This input device typically has two degrees of freedom in two axes, a first axis (e.g., x) and a second axis (e.g., y), that allows the device to specify positions in a plane. To detect user's gestures, the display 509 may incorporate a touchscreen interface configured to detect user's tactile events and send information on the detected events to the processor 505 via the bus 504.

An external storage device 512 may be coupled to the computer platform 501 via bus 504 to provide an extra or removable storage capacity for the computer platform 501. In an embodiment of the computer system 500, the external removable storage device 512 may be used to facilitate exchange of data with other computer systems.

The invention is related to the use of computer system 500 for implementing the techniques described herein. In an embodiment, the inventive system may reside on a machine such as computer platform 501. According to one embodiment of the invention, the techniques described herein are performed by computer system 500 in response to processor 505 executing one or more sequences of one or more instructions contained in the volatile memory 506. Such instructions may be read into volatile memory 506 from another computer-readable medium, such as persistent storage device 508. Execution of the sequences of instructions contained in the volatile memory 506 causes processor 505 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 505 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as the persistent storage device 508. Volatile media includes dynamic memory, such as volatile storage 506.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 505 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 504. The bus 504 carries the data to the volatile storage 506, from which processor 505 retrieves and executes the instructions. The instructions received by the volatile memory 506 may optionally be stored on persistent storage device 508 either before or after execution by processor 505. The instructions may also be downloaded into the computer platform 501 via Internet using a variety of network data communication protocols well known in the art.

The computer platform 501 also includes a communication interface, such as network interface card 513 coupled to the data bus 504. Communication interface 513 provides a two-way data communication coupling to a network link 514 that is coupled to a local network 515. For example, communication interface 513 may be an integrated services digital network (ISDN) card or a modem to provide a data communication connection to a corresponding type of telephone line. As another example, communication interface 513 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 513 sends and receives electrical, electromagnetic or optical signals that carry digital data streams representing various types of information.

Network link 514 typically provides data communication through one or more networks to other network resources. For example, network link 514 may provide a connection through local network 515 to a host computer 516, or a network storage/server 522. Additionally or alternatively, the network link 514 may connect through gateway/firewall 517 to the wide-area or global network 518, such as an Internet. Thus, the computer platform 501 can access network resources located anywhere on the Internet 518, such as a remote network storage/server 519. On the other hand, the computer platform 501 may also be accessed by clients located anywhere on the local area network 515 and/or the Internet 518. The network clients 520 and 521 may themselves be implemented based on the computer platform similar to the platform 501.

Local network 515 and the Internet 518 both use electrical, electromagnetic or optical signals that carry digital data streams. The signals through the various networks and the signals on network link 514 and through communication interface 513, which carry the digital data to and from computer platform 501, are exemplary forms of carrier waves transporting the information.

Computer platform 501 can send messages and receive data, including program code, through the variety of network(s) including Internet 518 and LAN 515, network link 515 and communication interface 513. In the Internet example, when the system 501 acts as a network server, it might transmit a requested code or data for an application program running on client(s) 520 and/or 521 through the Internet 518, gateway/firewall 517, local area network 515 and communication interface 513. Similarly, it may receive code from other network resources.

The received code may be executed by processor 505 as it is received, and/or stored in persistent or volatile storage devices 508 and 506, respectively, or other non-volatile storage for later execution.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as C/C++, Objective-C, perl, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the systems and methods for integrating content from different social networks on a single message wall. It is intended that the specification and examples be considered as exemplary only, with a true scope and spirit of the invention being indicated by the following claims.

What is claimed is:

1. A computerized system for integrating content from different social networks on a single message wall, the system comprising:
a. a pulling system comprising at least one processing unit and a memory for periodically collecting social media data based on a search query;
b. a message processing service comprising at least one processing unit and a memory for removing duplicates from the collected social media data and for saving the deduplicated collected social media data to a database;
c. a search service comprising at least one processing unit and a memory for indexing the deduplicated collected social media data; and
d. a front-end interface for displaying at least a portion of the deduplicated collected social media data to the user.

2. The computerized system of claim 1, wherein the pulling system comprises a pulling demon, a pulling worker and a database.

3. The computerized system of claim 2, wherein the database is Redis DB.

4. The computerized system of claim 1, wherein message processing service facilitates pre-moderation of the collected social media data.

5. The computerized system of claim 1, wherein message processing service facilitates post-moderation of the collected social media data.

6. A computer-implemented method for integrating content from different social networks on a single message wall, the method comprising:
a. using a pulling system comprising at least one processing unit and a memory for periodically collecting social media data based on a search query;
b. using a message processing service comprising at least one processing unit and a memory for removing duplicates from the collected social media data and for saving the deduplicated collected social media data to a database;
c. using a search service comprising at least one processing unit and a memory for indexing the deduplicated collected social media data; and
d. displaying at least a portion of the deduplicated collected social media data to the user.

7. The computer-implemented method of claim 6, wherein the pulling system comprises a pulling demon, a pulling worker and a database.

8. The computer-implemented method of claim 7, wherein the database is Redis DB.

9. The computer-implemented method of claim 6, wherein message processing service facilitates pre-moderation of the collected social media data.

10. The computer-implemented method of claim 6, wherein message processing service facilitates post-moderation of the collected social media data.

11. A non-transitory computer-readable medium embodying a set of computer-executable instructions, which, when executed in a computerized system comprising a central processing unit, a display device and a memory, cause the computerized system to perform a method for integrating content from different social networks on a single message wall, the method comprising:
a. using a pulling system comprising at least one processing unit and a memory for periodically collecting social media data based on a search query;
b. using a message processing service comprising at least one processing unit and a memory for removing duplicates from the collected social media data and for saving the deduplicated collected social media data to a database;
c. using a search service comprising at least one processing unit and a memory for indexing the deduplicated collected social media data; and
d. displaying at least a portion of the deduplicated collected social media data to the user.

12. The non-transitory computer-readable medium of claim 11, wherein the pulling system comprises a pulling demon, a pulling worker and a database.

13. The non-transitory computer-readable medium of claim 12, wherein the database is Redis DB.

14. The non-transitory computer-readable medium of claim 11, wherein message processing service facilitates pre-moderation of the collected social media data.

15. The non-transitory computer-readable medium of claim 11, wherein message processing service facilitates post-moderation of the collected social media data.
